(19) United States
(12) Patent Application Publication
(10) Pub. No.: US 2025/0317683 A1
(43) Pub. Date: Oct. 9, 2025

(54) COMMUNICATIONS HEADSET WITH FOCUSED DIRECTIONAL SPEAKERS

(71) Applicant: Atlantic Signal, LLC, Topeka, KS (US)

(72) Inventors: Mads Staerke, Frederiksberg C (DK); David J. Bondarenko, Topeka, KS (US); Cody Michael Stallbaumer, Topeka, KS (US); Eric Ryan Jones, Topeka, KS (US)

(73) Assignee: Atlantic Signal, LLC, Topeka, KS (US)

(21) Appl. No.: 19/170,565

(22) Filed: Apr. 4, 2025

Related U.S. Application Data
(60) Provisional application No. 63/575,464, filed on Apr. 5, 2024.

(51) Int. Cl. H04R 1/34; H04R 1/08; H04R 1/10

(52) U.S. Cl. CPC H04R 1/345; H04R 1/08; H04R 1/1008; H04R 1/1016; H04R 1/1025; H04R 1/1041; H04R 1/105; H04R 1/1075; H04R 1/1083; H04R 2201/107; H04R 2420/09; H04R 2430/01; H04R 2460/01

(57) ABSTRACT

A communications headset includes one or more directional speakers mounted in left and right temple housings positioned near a wearer's ears, with acoustic channels within the temple housings configured to direct sound waves toward the ear canals. The temple housings form an open-ear configuration, allowing external noises to reach the ears unobstructed. Each directional speaker is acoustically coupled to a contoured channel that delivers focused audio to the wearer's ear with minimal sound wave leakage. An in-ear speaker, magnetically secured and tethered to the temple housing, provides optional noise-isolated listening. A user-controlled selection switch allows a wearer to toggle between open-ear and in-ear modes. The headset also includes a boom microphone, volume controls, and USB charging and communication ports.

### CROSS-REFERENCE TO RELATED APPLICATIONS

The application claims the benefit of U.S. Provisional Patent Application No. 63/575,464 filed Apr. 5, 2024, the disclosure of which is hereby incorporated herein in its entirety by reference.

### FIELD

The present invention generally relates to communications headsets, and more particularly, to communications headsets with focused directional speakers.

### BACKGROUND

Conventional communications headsets are widely used in various industries, including aviation, military, law enforcement, emergency response, and commercial applications, to facilitate effective two-way communication. These headsets typically incorporate acoustic speakers that transmit sound waves from a radio receiver or other electronic circuitry into the wearer's ear canal. To enhance user comfort and improve sound isolation, many headsets feature an adjustable headband that extends over and across a wearer's head and supports left and right ear housings, each housing containing one or more speakers. Additionally, ear pads or covers are commonly used on each housing to provide passive noise attenuation, reducing the intrusion of ambient environmental noise.

In tactical and high-performance environments, such as military operations, law enforcement missions, and emergency response situations, clear and reliable audio communication is critical. Conventional headsets, however, often present challenges in these demanding settings. For instance, while some known headsets are designed with passive or active noise-canceling features to reduce unwanted background noise, blocking extraneous noise may also inadvertently block important environmental sounds. This can be detrimental in scenarios where situational awareness is essential, such as when personnel need to detect threats, hear approaching vehicles, or receive verbal instructions from team members without removing their headsets.

To address these issues with noise attenuating headsets, some manufacturers have introduced designs that incorporate ambient microphones or bone conduction technology to allow users to perceive external sounds while wearing the headset. While these designs offer some improvement, they can introduce additional complexities, such as increased power consumption, susceptibility to environmental interference, or reduced sound clarity. Furthermore, many traditional headset designs rely on omnidirectional or wide-field speaker configurations, which can cause audio leakage or reduced intelligibility in high-noise environments.

Tactical and military users, in particular, require communication headsets that offer both enhanced situational awareness and clear, focused audio transmission. For example, a soldier in a combat zone may need to communicate with their unit via radio while still being able to detect critical sounds in their surroundings, such as enemy movement or verbal commands from nearby personnel. Similarly, law enforcement officers conducting operations in urban environments must be able to communicate effectively without compromising their ability to hear traffic, alarms, or other external cues.

While existing solutions have attempted to balance between sound isolation and environmental awareness, there are typically trade-offs for those features in comfort, battery life, complexity, or performance. Thus, it can be seen that there remains a need in the art for an improved communications headset that effectively directs audio to the wearer without isolating them from important surrounding sound and noises.

### SUMMARY

The present invention relates to an improved communications headset having focused directional speakers and acoustic guide channels configured to enhance the transmission of sound from the speakers to the wearer's ears, for increased audio clarity without diminishing the wearer's ability to hear ambient and external sounds and noises.

In one aspect, the present invention provides an open-ear design having directional speakers mounted in temple housings worn near a wearer's temples, with acoustic channels formed in the temple housings and operable to direct sound waves from the directional speaker toward the user's ear canals. The configuration and design provides clear transmission of audio from the speakers to the wearer's ears without completely occluding the ears, thus allowing the wearer to simultaneously hear external noises and sounds, and maintain situational awareness.

In one embodiment, the headset comprises left and right temple housings, each of which serves as both a support structure and an acoustic conduit, with the housing thus physically supporting one or more directional speakers and also guiding sound waves from the directional speaker towards the wearer's ear canal. The directional speakers are preferably positioned within the temple housing such that the speakers are oriented to project sound waves through acoustic channels integrally formed within the temple housing. The acoustic channels are shaped to efficiently direct the sound waves toward the user's ear canal, ensuring that the audio remains focused and intelligible. Outlets of the acoustic channels are positioned and located along the temple housing, allowing sound to exit at optimal positions adjacent to the wearer's ear.

In one embodiment, each speaker is associated with a single acoustic channel that is split into two separate channel outlets. This configuration enhances sound dispersion while maintaining directional focus, ensuring that the audio remains clear and concentrated within the intended listening area. In this embodiment, the inner face of the temple housing contoured in an arc-like shape, curving gently toward the ear canal. This gentle curvature maximizes the sound delivery efficiency while minimizing sound leakage to the surrounding environment.

In one embodiment the headset includes an in-ear speaker. The in-ear speaker is magnetically secured to the temple housing and is further tethered to a rear leg of the temple housing to allow easy access so that the wearer can insert the in-ear speaker into the ear canal when enhanced audio isolation or noise suppression is required, such as in environments with gunfire, heavy machinery, or other high-decibel disturbances. In a preferred embodiment, the headset incorporates a switch attached to the temple housing. The switch allows the wearer to manually select between the directional speakers and the in-ear noise-suppressing speaker based on situational requirements. In normal operation, the temple housing directional speakers deliver focused yet open-audio communication, allowing the wearer to remain aware of ambient sounds. When noise suppression is needed, the wearer can switch the audio output to the in-ear speaker which attenuates background noise while maintaining clear communications.

The headset of the present invention thus provides a dual-mode audio system ideally suited for military personnel, law enforcement officers, and tactical operators, who often transition between environments where both situational awareness and noise suppression are critical. For example, during routine patrols or low-noise operations, the temple housing directional speakers and acoustic channels allow wearers to hear both their communications and the surrounding environment. In high-noise scenarios, such as combat, firearm engagements, or operating heavy vehicles, the wearer may insert the in-ear speaker and activate its noise suppression mode, thus protecting their hearing while still receiving clear radio transmissions.

### BRIEF DESCRIPTION OF THE FIGURES

FIG. 1 is a rear view of the communications headset with focused directional speakers in accordance with an exemplary embodiment of the present invention.

FIG. 2 is a right side view of the communications headset with focused directional speakers of FIG. 1.

FIG. 3 is a bottom view of the communications headset with focused directional speakers of FIG. 1.

FIG. 4 is a bottom perspective view of the communications headset with focused directional speakers of FIG. 1.

FIG. 5 is a left side rear perspective view of the communications headset with focused directional speakers of FIG. 1.

FIG. 6 is a right side view of the communications headset with the outer housing removed viewed along line 6-6.

FIG. 7 is a partial sectional view of the communications headset of FIG. 6 along line 7-7.

FIG. 8 is a partial sectional view of the communications headset of FIG. 6 viewed along line 8-8.

FIG. 9 is a partial sectional left side view of the communications headset viewed along line 9-9.

### DETAILED DESCRIPTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. The drawings constitute a part of this specification and include exemplary embodiments of the present invention and illustrate various objects and features thereof.

Certain terminology will be used in the following description for convenience in reference only and will not be limiting. For example, the words “upwardly,” “downwardly,” “rightwardly,” and “leftwardly” will refer to directions in the drawings to which reference is made. The words “inwardly” and “outwardly” will refer to directions toward and away from, respectively, the geometric center of the embodiment being described and designated parts thereof. Said terminology will include the words specifically mentioned, derivatives thereof and words of a similar import.

The present application is directed to a communications headset with focused directional speakers supported in a temple housing, with the soundwave output of the speakers directed into physical acoustic channels formed in the housing, with channel outputs positioned in close proximity to a wearer's ear.

The headset features an open-ear design, employing temple-mounted speakers that direct sound waves through carefully engineered acoustic channels toward the user's ear canal, ensuring clear, focused audio delivery while minimizing external sound leakage. The temple housing further forms a “U”-shaped opening so that the wearer's ear canal is substantially exposed to allow them to hear external noises and sounds in addition the directed sound emanating from the speakers. In one embodiment an in-ear speaker is magnetically removably attached to the temple housing, as well as tethered, to allow a wearer to easily access and insert the in-ear speaker in situations where external sound and noise needs to be suppressed or cancelled and returned to the magnetic mount when no longer needed. A switch on the temple housing allows the wearer to select between the directional speaker or the in-ear speaker as desired.

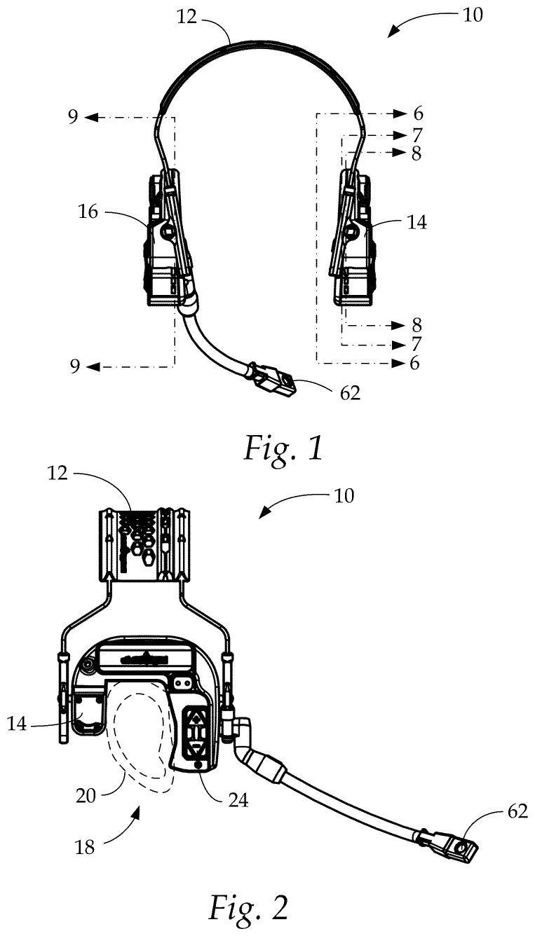

Looking first to FIG. 1, a rear-view of a communications headset with focused directional speakers in accordance with an exemplary embodiment of the present invention is designated by the numeral 10. The communications headset comprises right and left temple housings 14, 16 connected at opposite ends of an adjustable headband 12. In use, adjustable headband 12 extends across the top of a wearer's head, with the right and left temple housings 14, 16 supported and positioned over the wearer's left and right ears, respectively.

Each of the left and right temple housings preferably contain and house communications and control circuitry, allowing the headset 10 to interface with various communications radios to transmit and receive voice communications. The communications and control circuitry may include analog and digital communications circuitry, power supply circuitry, and interface circuitry. A rechargeable battery is preferably included within either, or both, of the left and right temple housings 14, 16 to power the contained circuitry.

An adjustable microphone 62 is attached to the left temple housing, the microphone 62 comprising a flexible shaft allowing the microphone mouthpiece to be positioned as desired by a wearer within proximity of the wearer's mouth. A cable extending within the flexible positioning shaft connects the microphone 62 to the communications and control circuitry within the left temple housing.

Looking to FIG. 2 in conjunction with FIG. 1, the right temple housing 14 is shaped in an inverted “U”-configuration with the open portion of the “U” providing a space to accommodate the wearer's ear 20, with the temple housing 14 partially surrounding the ear 20 but leaving the wearer's ear canal an unobstructed inlet to ambient noises and sounds.

As also seen in FIG. 2 a volume control switch 24 positioned on the right temple housing 14 is in electrical communication with the communications and control circuitry housed within the temple housing, allowing a user to control the volume of transmissions emanating from speakers positioned within the temple housings 14, 16 (as will be described in more detail below).

Right and left temple housings 14, 16 are preferably pivotably attached to wire frame supports extending from each end of the headband 12 to allow the housings to rotate to provide a comfortable fit of the headset 10 to the sides of a wearer's head.

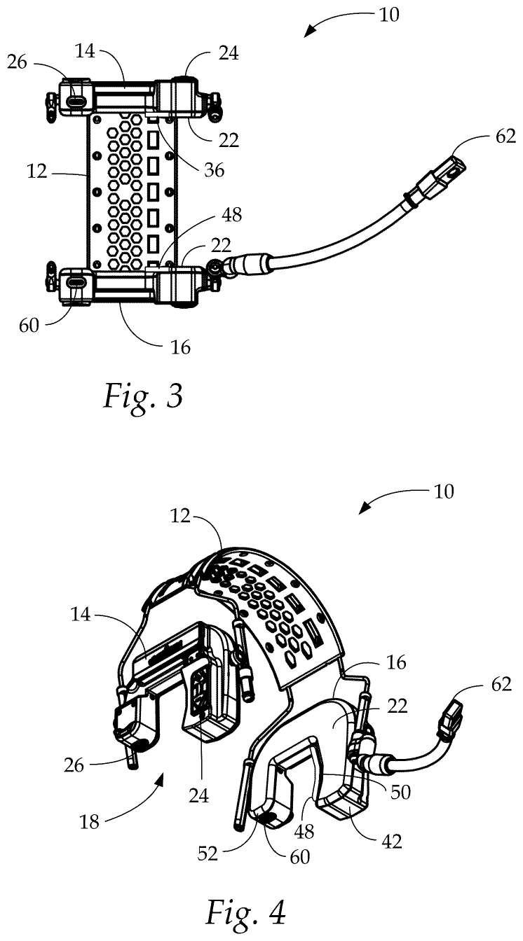

Turning to FIGS. 3 and 4, bottom and bottom perspective views of the communications headset with focused directional speakers 10 of FIG. 1 are depicted. As seen in the figure the, headband 12 extending between the right and left temple housings 14, includes a series of perforations or apertures formed therethrough to provide flexibility of the head band as well as comfort to the wearer.

As further seen in the figures, each of the right and left temple housings 14, 16 include a USB port (26 and 60, respectively). Each USB port 26 and 60 is in electrical communication with the communications and control circuitry within the temple housing 14, 16 to allow charging internal batteries for powering the circuitry, and to facilitate communication or data communication with external devices, such as laptop computers, cell phones, or communications radios.

Each of the right and left temple housings 14, 16 further comprise padding 22 positioned attached along the inner face of the housing to provide a comfortable fit of the housing around the wearer's ear and against the side of the wearer's head. As further seen in the figures, each of the left and right temple housings 14, 16 comprise a projecting wall 36, 48 positioned to direct sound output from speakers within the temple housings as will be described in more detail below.

Looking to FIGS. 3, 4, and 5 in conjunction, it can be seen that the inverted “U”-shaped left temple 16 housing forms front 42 and rear 52 “legs”, with the right temple housing 14 similarly comprising corresponding legs. The front legs are configured to engage the wearer's head forward of their ears, with the rear legs configured to engage the wearer's head behind their ears.

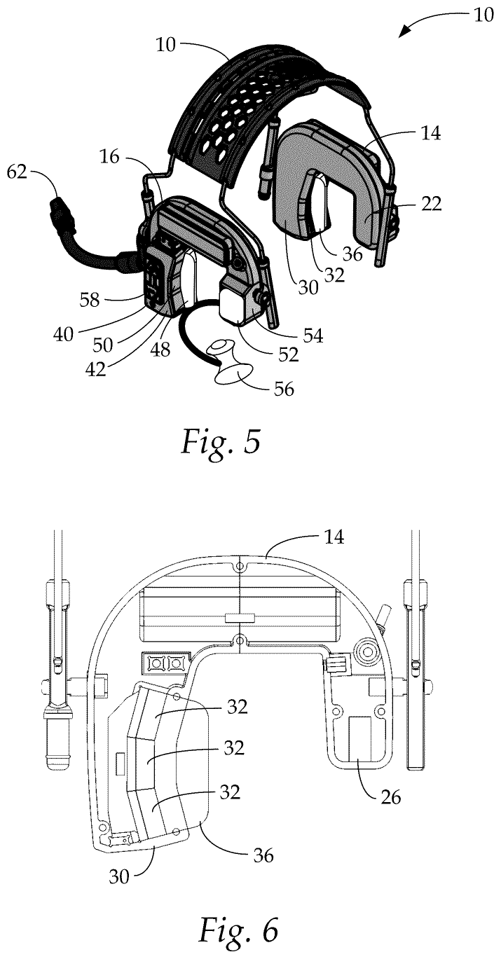

As best seen in FIG. 5, the rear leg 52 of the left temple housing 16 includes an in-ear speaker 56 configured to provide an alternative audio delivery mechanism in the event a wearer wants to block and/or cancel ambient or external sounds and noises. The in-ear speaker is electrically coupled to the communications and control circuitry housed in the temple housing 16 and thus is operable to receive the same audio signal from the communications circuitry as the directional speakers which provide audio to the acoustic channels formed within the temple housings.

The in-ear speaker 56 is removably secured to the rear leg 52 by means of a magnet 54 embedded within the housing of the rear leg 52. Magnetic retention allows the in-ear speaker 56 to be quickly detached and inserted into the user's ear canal as required, and to be similarly reattached to the headset when not in use. The wiring between the in-ear speaker 56 and the communications and control circuitry further acts as a tether to secure the in-ear speaker to the temple housing.

As briefly described above, selection switch 58 in the left temple housing 16 is operable to switch the communications circuitry to either the directional speakers 28, 40 or to the in-ear speaker 56. When the in-ear speaker 56 is selected, the communication and control circuitry preferably deactivates or attenuates the directional speaker output to prevent redundant audio output. Selection switch 58 thus allows the wearer to transition between open-ear and in-ear listening modes depending on the operational environment. Thus, for example, in high noise situations the wearer may switch to the in-ear speaker to block ambient noises while enhancing the ability to hear the transmitted communications. In a preferred embodiment, the interface circuitry for the in-ear speaker includes noise cancellation circuitry to further enhance the ability to block external sounds.

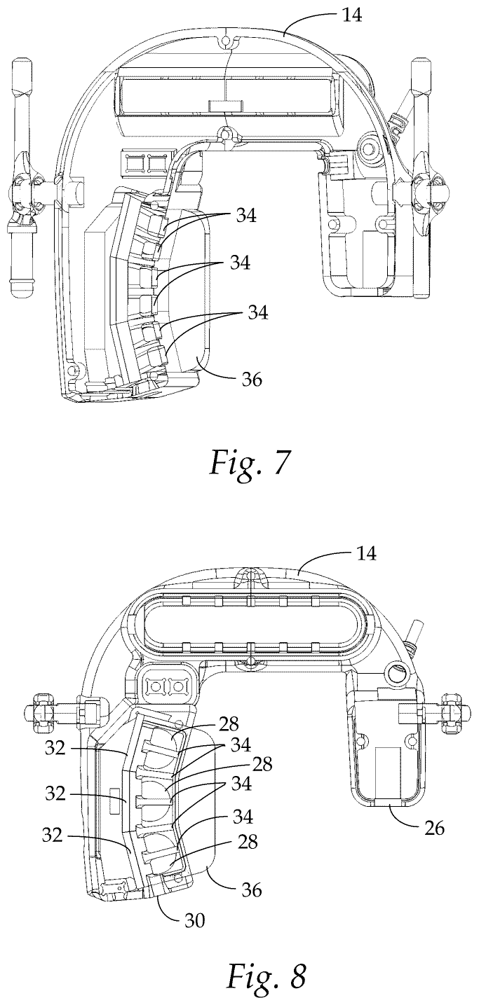

Turning to FIGS. 6 through 9, the interior structure of the temple housing and the acoustic channels for directing sound from directional speakers to the wearer's ears will now be described. As described previously, in the embodiment illustrated, the right temple housing 14 includes a front leg 30 extending generally forward from the headband 12 and shaped to extend along the temple region of the wearer, adjacent to their ear 20.

As seen in FIGS. 6 through 9, one or more directional speakers 28 are supported within the temple housing 14, positioned and oriented to emit sound waves signals into the corresponding acoustic channels 32 formed within the structure of the front leg 30 of the temple housing 14. Each of the acoustic channels 32 is configured to extend from the location of the speaker 28 downwardly and rearwardly, sloping in a direction away from the speaker and generally toward the side of the wearer's head.

The orientation and geometry of the channels 32 are configured such that emitted sound waves from the directional speaker(s) 28 are guided along a defined acoustic path, terminating in one or more channel outlets 34 formed in the outward-facing sidewall of the front leg 30. The outlets 34 are positioned in close proximity to the user's ear canal to direct the sound waves toward the auditory opening of the ear, without occluding it, allowing the user to clearly hear voice transmissions emanating from the directional speakers, while simultaneously allow ambient sounds and noises to enter the ear canal unobstructed. Thus, the wearer may clearly hear both the transmitted audio/voices as well as ambient sounds.

To further control the propagation of sound waves from the directional speaker(s) 28, the front leg 30 includes a wall or projection 36 extending outwardly from the front leg adjacent the acoustic path of the channels 32. The projection 36 is generally aligned parallel to the direction of acoustic wave output from the channels 32 and functions as a baffle or guide to funnel and contain the sound waves, thereby increasing the directional travel of the signal toward the ear canal and limiting lateral propagation of the sound waves. acoustic leakage. The integration of the projection 36 with the curved sidewall of the front leg 30 further assists in guiding the direction of travel of the sound waves.

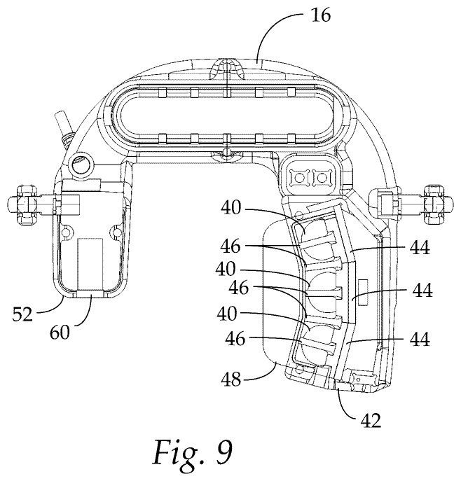

Looking to FIG. 9, the acoustic channels within the right temple housing 16 are formed, and function, similarly to the acoustic channels as just described with respect to the left temple housing 14. Left temple housing 16 includes a front leg or front leg 42 configured to extend along the left of the user's head, generally mirroring the structure and function of the right-side front leg 30. One or more directional speakers 40 are mounted and positioned within the left front leg 42, with the speaker(s) 40 oriented to direct sound waves into a set of sloped channels 44 formed within the body of the front leg. Each channel 44 is contoured to slope downwardly and rearwardly in the direction of the wearer's ear, forming an acoustic path from the speaker(s) toward the side of the user's head.

The channels 44 are configured to direct the sound waves directly towards the wearer's ear canal while the structure of the left temple housing forms an open-ear configuration to allow ambient and external noises to simultaneously enter the wearer's ear canal. Channels 44 terminate in channel outlets 46 positioned along the side of the front leg 42 and adjacent to the wearer's ear, such that the audio signals are directed toward the ear canal without obstructing it

The front leg 42 further includes an outwardly extending wall or projection 48 that acts to direct the sound waves toward the wearer's ear canal and to limit any lateral dispersion. The projection 48 is positioned adjacent to the output end of the channels 44 and extends in a direction generally parallel to the travel of the sound waves. In preferred embodiments, the sidewall of the front leg 42, including the projection 48, may be formed in an arced configuration that curves toward the wearer's ear.

As used in the following claims, identification of an element with an indefinite article “a” or “an” or the phrase “at least one” is intended to cover any device assembly including one or more of the elements at issue. Similarly, references to first and second elements is not intended to limit the claims to such assemblies including only two of the elements, but rather is intended to cover two or more of the elements at issue. Only where limiting language such as “a single” or “only one” with reference to an element, is the language intended to be limited to one of the elements specified, or any other similarly limited number of elements.

1. A communications headset, comprising:
a headband;
a right temple housing and a left temple housing mounted to opposite ends of the headband;
a directional speaker positioned within at least one of the right and left temple housings;
at least one acoustic channel formed in at least of the temple housings, the acoustic channel configured to direct sound waves from the directional speaker toward an ear canal of a wearer;
at least one channel outlet configured to be positioned adjacent to a wearer's ear canal for delivering the directed sound waves;
a wall or projection extending parallel to the at least one acoustic channel to funnel the sound toward the wearer's ear while reducing audio leakage; and
a curved side surface of a front leg of the temple housing, shaped to conform to a wearer's head and orient the channel outlet toward the ear canal.

2. The communications headset of claim 1, wherein the acoustic channel is sloped inwardly from the speaker toward the channel outlet to optimize sound wave transmission.

3. The communications headset of claim 1, wherein the front leg comprises a plurality of directional speakers, each directing sound through separate acoustic channels.

4. The communications headset of claim 1, wherein the wall or projection comprises a sound-reflecting surface to enhance directionality and minimize sound loss.

5. The communications headset of claim 1, further comprising ear pads positioned on an inner surface of each of the right and left temple housings.

6. The communications headset of claim 1, further comprising a microphone coupled to one of the right or left housings.

7. The communications headset of claim 1, wherein the curved side surface of the front leg is shaped in an arc-like configuration to optimize alignment of sound waves to the wearer's ear canal.

8. A communications headset, comprising:
a headband;
a right temple housing and a left temple housing mounted to opposite ends of the headband;
a directional speaker positioned within a front leg of at least one of the right and left temple housings;
an acoustic channel system configured to direct sound from the speaker toward a wearer's ear canal;
an in-ear speaker removably secured to a rear leg of one of the temple housings;
a tether connecting the in-ear speaker to the temple housing; and
a selection switch operable to selectively toggle audio output between the directional speaker and the in-ear speaker.

9. The communications headset of claim 8, wherein the in-ear speaker is removably secured via a magnet.

10. The communications headset of claim 8, wherein the in-ear speaker comprises noise cancellation circuitry to reduce ambient noise.

11. The communications headset of claim 8, wherein the selection switch is positioned on a front leg of one of the right or left temple housings.

12. The communications headset of claim 8, wherein activation of the in-ear speaker deactivates the directional speaker.

13. A communications headset, comprising:
a headband supporting a right temple housing and a left temple housing;
a directional speaker system comprising at least one directional speaker positioned within a front leg of at least one of the temple housings;
an acoustic channel structure configured to direct sound waves from the directional speaker system toward a wearer's ear canal;
an in-ear speaker removably secured to a rear leg of the housing via a magnet;
a selection switch configured to select between the directional speaker system and the in-ear speaker;
a USB port integrated into at least one of the right or left temple housings and operable to charge a battery within at least one of the left or right temple housings; and
an adjustable microphone attached to one of the temple housings.

14. The communications headset of claim 13, wherein the USB port is configured to charge a battery and to facilitate data transmission to external communication devices.

15. The communications headset of claim 13, wherein the USB port supports a wired audio connection to a communications radio.

16. The communications headset of claim 13, further comprising a volume control for adjusting audio levels.

17. The communications headset of claim 13, wherein the adjustable microphone is a boom microphone with a flexible arm for positioning near a wearer's mouth.

18. The communications headset of claim 13, wherein communications and control circuitry within the left or right temple housings comprises active noise cancellation circuitry in communication with the in-ear speaker.
